(19) United States
(12) Patent Application Publication
(10) Pub. No.: US 2005/0161906 A1
(43) Pub. Date: Jul. 28, 2005

(54) Transport assistance device for large, wheeled refuse containers

(76) Inventor: Brian L. Thelen, Waukesha, WI (US)

Correspondence Address: Brian Thelen, W319 S3997 Irene Court, Waukesha, WI, 53189-9587, US

(21) Appl. No.: 10/740,010

(22) Filed: Dec. 19, 2003

(51) Int. Cl. B60D 1/01

(52) U.S. Cl. 280/504

(57) ABSTRACT

This invention relates generally to vehicle attachments, in particular to a device that enables vehicle-powered towing of large, wheeled refuse containers. The devices used in this invention disclose a support structure which accommodates a variety of vehicle hitch and refuse container heights, a hook attached in a way to permit large vertical motion while rotational motion about a vertical axis is restricted, and a movable locking device that is integral to the hook. The support structure mounts into a typical trailer hitch receiver mounted to a vehicle. A transverse snubber bar extending from the support structure prevents the container from being crushed in the event of vehicle reversal. The hook is attached to the support structure and is configured to connect to an element on a large wheeled refuse container, then allow that connection point to be vertically repositioned tipping the container forward. This action allows the center of gravity of the container to be rotated from behind the containers wheels, to a point forward of the wheels for towing.

### BACKGROUND OF THE INVENTION

This invention relates generally to vehicle attachments, in particular to a towing device enabling a user to easily move a large, wheeled refuse container from loading location to curbside pickup point.

An emerging trend in home or small business refuse and recycling collection involves the use of trucks that are equipped with hydraulic gripper arms that grasp specifically configured large wheeled refuse containers. These arms are arranged to lift the containers to a dumping level within the body of the truck, dump them, and return them empty to the curbside. The waste industry refers to this collection method as “Automatic Refuse Collection”. This method increases the efficiency of the collection process.

Generally speaking, these large, wheeled refuse containers are substantially larger than traditional 30-gallon metal trash cans, being typically 60 to 100 gallons in volumetric capacity. These large refuse containers are usually arranged with at least a pair of wheels, allowing them to be tipped onto the wheels and while so balanced, manually moved by the user. These large wheeled containers are able to handle heavy loads, having weight capacities ranging as high as 350 pounds.

When a large refuse container is heavily loaded, it is likely to become unwieldy to physically maneuver in some instances. In hilly conditions, gravel or dirt driveways, for frail users, in black ice and/or snow conditions, or combinations of these conditions the prospect of moving the container from loading location to curbside may become humanly difficult, if not impossible. This device facilitates the transfer of the large wheeled refuse containers by minimizing the physical effort required. Anyone having access to a vehicle with standard trailer hitch can employ this device to make use the power and stability of a vehicle to re-position the container from load point to pickup point.

### SUMMARY OF THE INVENTION

The principle object of the present invention is to provide a device that allows a user to easily move a large wheeled refuse container, when attendant conditions make manual transport difficult. Such conditions could include the users physical ability, slippery or uneven surface conditions, slope considerations and/or heavy loads.

Still another object of the invention is to provide an apparatus for securing a load to a vehicle which can be quickly and easily mounted in position to the vehicle and on which the load can be readily fitted.

In preparation for refuse pickup on the scheduled collection day, the user attaches the transport assistance device to a vehicle. The vehicle can then be moved to the vicinity of the large wheeled refuse container. The container is maneuvered into position with reference to the transport assistance device. The grabber hook is then positioned on an element of the container and its locking device is moved into locked position, capturing the container to the vehicle. The large wheeled refuse container is then manually rotated, thereby tipping it onto its wheels.

This range of container movement is controlled by a joint that allows the grabber large vertical motions while maintaining torsional rigidity about the vertical axis established by the main support structure. The vehicle is then driven to the road, where it's maneuvered to place the container at or near the pickup position. The grabber hook lock device is then released, and the grabber hook disconnected from the container. The large wheeled refuse container is manually positioned, as required, for automated pickup, and the vehicle is driven away, taking this transport assistance device with it.

### A BRIEF DESCRIPTION OF THE DRAWINGS

FIG. 1 is a side view generally showing the overall transport assistance device and the relative positions of its elements with respect to a large wheeled refuse container and vehicle trailer hitch receiver,

FIG. 2 is a top view of the transport assistance device with respect to a large wheeled refuse container and vehicle trailer hitch receiver; and

FIG. 3 is a side view generally showing the overall transport assistance device with the large wheeled refuse container shown in transport attitude.

### DESCRIPTION OF THE PREFERRED EMBODIMENT

In fulfillment and implementation of the previously cited objects, there is shown in the accompanying drawings a form thereof which is at present preferred, although it is to be understood that the several instrumentalities of which the invention exists can be variously arranged and organized and that the invention is not limited to the precise arrangements and organizations of the instrumentalities as herein shown and described in the drawings, wherein like reference characters indicate like parts:

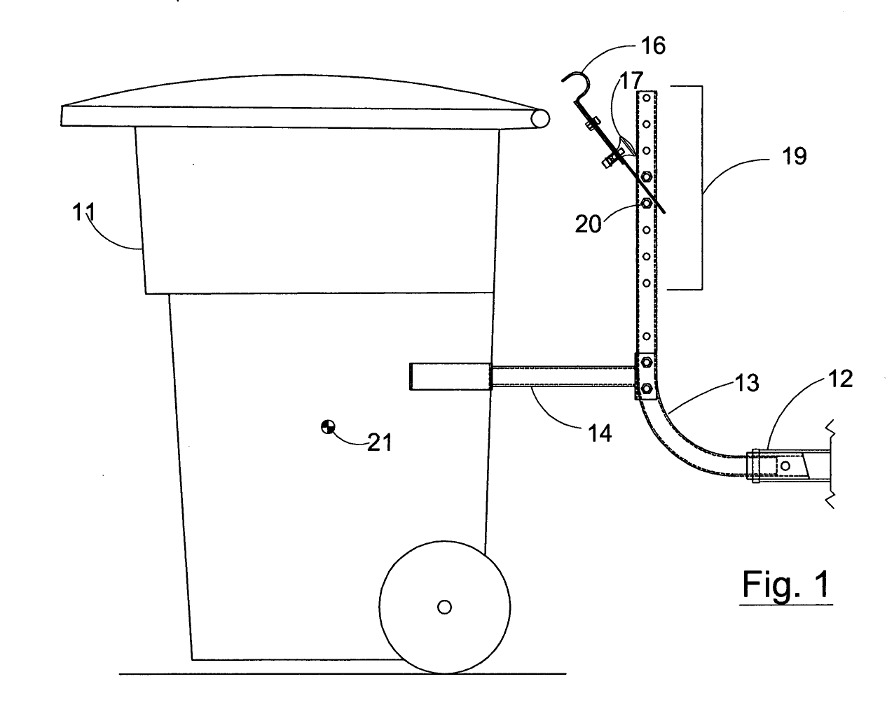

Now referring to FIG. 1, a large wheeled refuse container is shown and identified as numeral 11. A standard vehicle trailer hitch receiver is shown and generally identified as numeral 12. The main support structure is indicated by numeral 13. The variable position mounting locations for the grabber hook are indicated by numeral 19. Location of the grabber hook position on the main support structure is established and maintained within adjustable constraints indicated as numeral 20. A snubber bar assembly is generally identified as numeral 14. A grabber hook assembly of a configuration dependent on an element of the large wheeled refuse containers physical geometry is shown as numeral 16. A detent mechanism that facilitates holding the positive locking device to either the locked or unlocked position is shown as numeral 17. The center of gravity of the refuse container, while variable in position with the character of the load, is generally indicated as numeral 21.

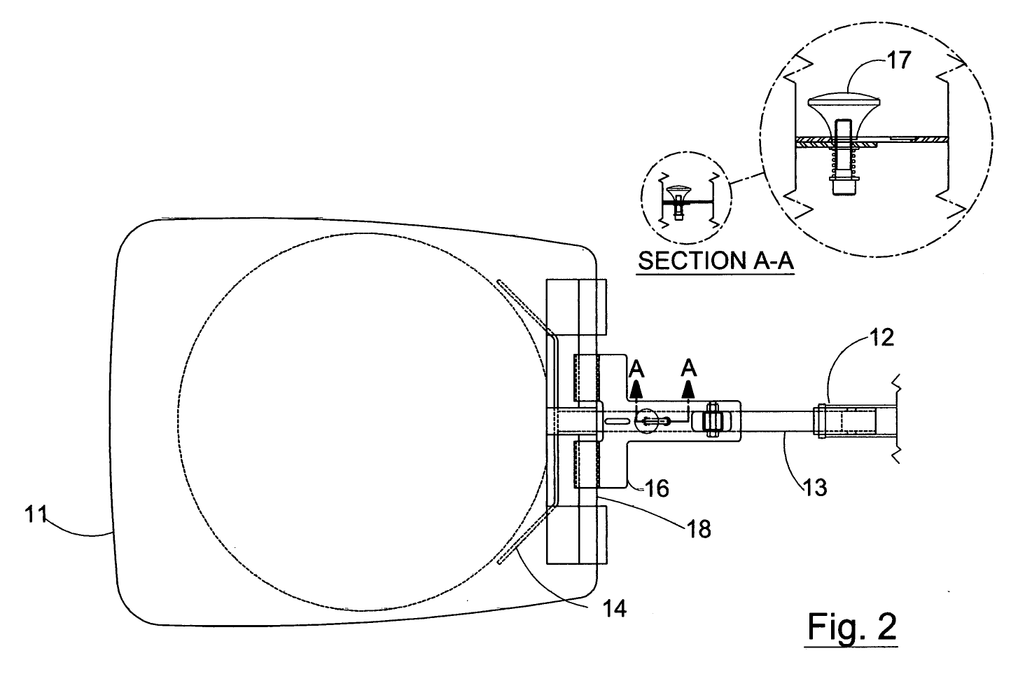

Now referring to FIG. 2, a large wheeled refuse container is shown and identified as numeral 11. A standard vehicle trailer hitch receiver is shown and generally identified as numeral 12. The main support structure is indicated by numeral 13. A snubber bar assembly is generally identified as number 14. A grabber hook of a configuration dependent on an element integral to the large wheeled refuse containers physical geometry is shown as numeral 16. A detent mechanism that facilitates holding the locking device to either the locked or unlocked position is shown as numeral 17. The lid hinge pin of a large wheeled refuse container is generally indicated as numeral 18.

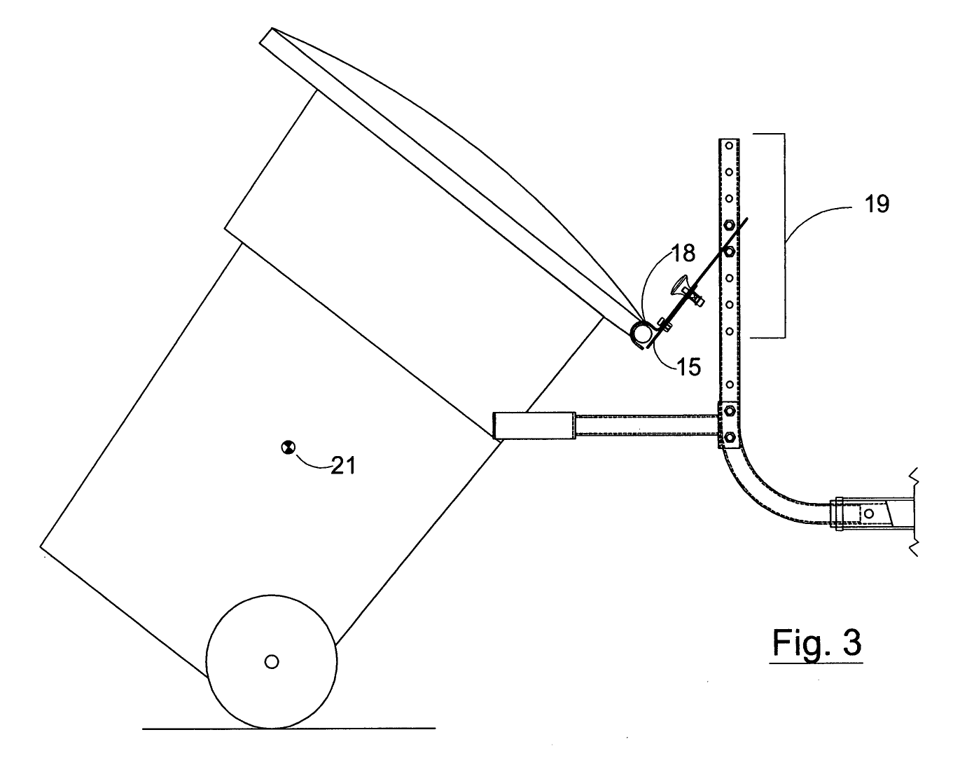

Now referring to FIG. 3, a positive locking device that secures the grabber hook to the large wheeled refuse container is generally indicated as numeral 15. The lid hinge pin of a large wheeled refuse container is generally indicated as numeral 18. The variable position mounting area for the grabber hook is shown as a series of apertures generally indicated as numeral 19. The center of gravity of the refuse container in transport attitude, is generally indicated as numeral 21.

It is to be understood that the present invention may be embodied in other specific forms without departing from the spirit or special attributes hereof, and it is, therefore, desired that the present embodiments be considered in all respects as illustrative, and therefore, not restrictive, reference being made to the claims rather than to the foregoing description to indicate the scope of the invention.

1. A vehicle-mounted transport assistance device for towing a large, wheeled refuse container, comprising:
a. a main support structure for providing a mechanical connection from a vehicle to said refuse container;
b. a hook on said support structure adapted to positively grip an element on said refuse container;
c. a positive locking device integral to said hook; and
d. a transverse snubber bar on said support structure.

1. The structure as set forth in claim 1, wherein said hook is a grabber assembly, and provides a plurality of locations for accommodating variations in position of said hook, said hook adapted to grasp the hinge pin on said refuse container.

2. The structure as set forth in claim 1, wherein said positive locking device adjusts between unlocked and locked positions and is held in the selected positions by a detent mechanism.

3. The structure as set forth in claim 1, wherein said snubber bar assembly is coupled to said main support structure.
